(19) United States
(12) Patent Application Publication
(10) Pub. No.: US 2026/0144182 A1
(43) Pub. Date: May 28, 2026

(54) SEED COATING COMPOSITION

(71) Applicant: CRODA, INC., Plainsboro, NJ (US)

(72) Inventors: Tyler Alan REECE, Salinas, CA (US); Brian Charles TLACH, Salinas, CA (US)

(73) Assignee: CRODA, INC., Plainsboro, NJ (US)

(21) Appl. No.: 19/122,044

(22) PCT Filed: Oct. 26, 2023
(86) PCT No.: PCT/US2023/035965

§ 371 Date: Apr. 17, 2025

Related U.S. Application Data
(60) Provisional application No. 63/422,167, filed on Nov. 3, 2022.

(51) Int. Cl. A01C 1/06; A01N 25/00; A01P 3/00; A01P 7/04

(52) U.S. Cl. CPC A01C 1/06; A01N 25/004; A01P 3/00; A01P 7/04

(57) ABSTRACT

A novel seed coating composition. Said coating comprising wax emulsion, polymeric binder, fibrous material, and filler with bulk density from 0.05 to 0.80 g/mL. In particular, the coating is selected from polyethylene or Fischer Tropsch wax emulsions, polyvinyl based binders, talc, and cellulose fibres. The seed coating composition when applied to a seed provides water permeability, good abrasion resistance, low dust emissions, short drying time, good flow ability and plant ability, low clumping, good cosmetics and/or coverage, higher capacity for adding increased numbers of desirable nutrients and seed and plant protectants, and/or increased seed size for plantability. There is also provided the use of said seed coating composition for coating seeds, a method of formed a coated seed using said composition, and the resulting coated seed.

### CROSS REFERENCE TO RELATED APPLICATIONS

This application is the U.S. National Phase of International Application No. PCT/US2023/035965, filed on Oct. 26, 2023, which claims priority to U.S. Provisional Application No. 63/422,167, filed on Nov. 3, 2022, the content of each of which is incorporated herein by reference in its entirety for all purposes.

### FIELD OF THE INVENTION

The present invention is directed to a seed coating composition, to a method of forming a seed coating composition and coating on to seed, and to a coated seed.

### BACKGROUND OF THE INVENTION

Plant seeds are often coated before sowing, for example, to protect seeds from damage during handling and/or to improve handling properties. Seeds are often coated to provide useful substances (active ingredients) to the seed and the seedlings upon germination, for example, plant nutrients, growth stimulating agents, and plant protective products. An important advantage of providing active ingredients in a seed coating is that it allows for a precise and controlled release and dose per seedling.

Advantages of coating seed can include increased size, increased chemical loading capacity, abrasion resistance, smooth surface, low dust, high plantability and good durability. Typical seed coating methods include film coating, pelleting and encrusting of seed.

The present invention seeks to provide a seed coating composition, to provide improved aforementioned properties and have a reduced drying requirement.

### SUMMARY OF THE INVENTION

Accordingly, in a first aspect the invention is directed to a seed coating composition comprising;
wax emulsion;
polymeric binder;
filler selected from those with bulk density in the range 0.05 to 0.80 g/mL; and fibrous material.

According to a second aspect of the present invention there is provided a method of forming a seed coating composition which comprises combining
a dry or substantially dry composition pre-blend comprising a filler selected from those with bulk density in the range 0.05 to 0.80 g/mL, and a fibrous material; and
a liquid pre-blend comprising wax emulsion and polymeric binder.

According to a third aspect of the present invention there is provided a method of coating seed which comprises applying a seed coating composition comprising a wax emulsion, polymeric binder, filler selected from those with bulk density in the range 0.05 to 0.80 g/mL, and a fibrous material.

According to a fourth aspect of the invention, there is provided a seed with a coating comprising wax emulsion, polymeric binder, filler selected from those with bulk density in the range 0.05 to 0.80 g/mL, and a fibrous material.

According to a fifth aspect of the invention, there is provided the use of a seed coating composition comprising wax emulsion, polymeric binder, filler selected from those with bulk density in the range 0.05 to 0.80 g/mL, and a fibrous material, to reduce drying time when the composition is coated onto seed.

### DETAILED DESCRIPTION OF THE INVENTION

The seed coating compositions of the invention are surprisingly able to provide a wide range of desirable seed coating properties such as water permeability, good abrasion resistance, low dust emissions, short drying time, good flow ability and plant ability, low clumping, good cosmetics and/or coverage, higher capacity for adding increased numbers of desirable nutrients and seed and plant protectants, and/or increased seed size for plantability.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure, and are not meant to be limiting in any fashion.

The term “coating” as used in this application, is meant to refer to applying material to a surface of a seed, for instance as a layer of a material around a seed. Coating includes film coating, pelleting, and encrusting or a combination of these techniques as known in the art. The coating is preferably applied over substantially the entire surface of the seed, such as over 90% or more of the surface area of the seed, to form a layer. However, the coating may be complete or partial, for instance over 20% or more of the surface area of the seed, or 50% or more.

The term “seed coating composition” as used in this application is meant to refer to a composition to be used for coating of seed, possibly after combination with other additives, such as plant protective product formulations, diluents such as water, nutrients, and/or inoculants such as beneficial fungi or bacteria. Hence, the term includes both compositions that do and do not contain plant protective product formulations.

The term “plant enhancing agent” as used in this application is meant to refer to any component that is directly or indirectly advantageous for a plant or a plant seed, for instance through a biological effect on the plant, seed, or on organisms harmful for a plant such as fungi, pests and insects. Plant enhancing agents include plant protective products, safeners, growth promoters, growth regulators, nutrients, and the like.

The term “different location” as used in this application is meant in different mixing vessels, preferably in different buildings or premises, more preferably at least 5 miles apart. Thus, in one embodiment, the aqueous composition pre-blend and powder pre-blend, as defined herein, are prepared separately by mixing their relevant individual components, and then packaged, stored and/or transported and are only thereafter combined together, with other optional components, e.g. biologically active ingredients, at a different location to form the seed coating composition.

The term “dry or substantially dry” as used in this application means a composition which is free or substantially free of liquid. It is intended that the term means that preferably the composition less than 5 wt. % of liquid, more preferably less than 3 wt. %, further preferably less than 2 wt. %, even further preferably less than 1 wt. %, and particularly less than 0.5 wt. % based on the total weight of the composition. In a particularly preferred embodiment the composition may be free of any liquid.

The seed coating composition comprises wax emulsion.

The wax emulsion may be selected from the group consisting of natural wax, mineral wax and synthetic wax or a combination thereof.

Preferably, the wax emulsion is selected from the group consisting of polyethylene wax, carnauba wax, paraffin wax, polypropylene wax, oxidised polyethylene wax, montan wax, ceresin wax, ozocerite, peat wax, Fischer Tropsch wax, amide wax, ethylene acrylic acid wax, polyolefin wax, ethylene bis stearamide wax, bees wax, lanolin wax, sugar cane wax, palm wax, and vegetable wax.

In a preferred embodiment, the wax is selected from the group consisting of polyethylene wax, Fischer Tropsch wax, and carnauba wax.

It is also possible that mixtures of two or more waxes are present in the seed coating composition of the invention.

The wax emulsion can be an anionic wax, a non ionic wax or a cationic wax. Most preferably, the wax can be anionic or non ionic. Cationic waxes may give rise to flocculation problems when the seed coating composition is combined with anionically stabilised active ingredients.

The wax emulsion used herein suitably has a molecular weight (weight average) in the range from 1,000 to 40,000, preferably 5,000 to 20,000, more preferably 9,000 to 11,000, particularly 9,500 to 10,500, and especially 9,800 to 10,200.

The molecular weight (weight average) of the wax emulsion described herein can be determined by techniques well known in the art such as light scattering, size exclusion HPLC or mass spectrometry, preferably by mass spectrometry.

The pH of the wax emulsion may be in the range from 5 to 10. More preferably, in the range from 6 to 9. Further preferably, in the range from 7 to 9. Most preferably, in the range from 7.5 to 8.5.

The seed coating composition comprises polymeric binder, such that one or more polymeric binders are present in the seed coating composition of the present invention.

The at least one polymeric binder is preferably an organic polymeric binder, more preferably a synthetic polymeric binder.

The polymeric binder may, for example, be selected from the group consisting of polyvinyl acetates, polyvinyl acetate copolymers, polyvinyl alcohols, polyvinyl alcohol copolymers, polyurethane, celluloses (including ethylcelluloses, methylcelluloses, hydroxymethylcelluloses, hydroxypropylcelluloses, carboxymethylcelluloses, and hydroxymethylpropyl celluloses), polyvinylpyrrolidones, dextrins, maltodextrins, starches, polysaccharides, fats, oils, proteins, gum arabics, shellacs, vinylidene chloride, vinylidene chloride copolymers, calcium lignosulphonates, polyacrylates, acrylic copolymers, polyvinylacrylates, zeins, casein, gelatine, chitosan, pullulan, polyethylene oxide, polyethylene glycol, acrylamide polymers, acrylamide copolymers, polyhydroxyethyl acrylate, methylacrylamide polymers, poly(N vinylacetamide), sodium alginate, polychloroprene and syrups. These binders may be used alone or in combination of two, or three, or more. Preferred binders can be selected from the group consisting of polyvinyl acetates, polyvinyl acetate copolymers, polyvinyl alcohols, polyvinylpyrrolidones, and polyacrylates, particularly polyvinylpyrrolidones, vinyl acetate copolymers and polyvinyl alcohols.

In one embodiment, the polymeric binder in the coating composition comprises polyvinylpyrrolidone, and suitably greater than 30%, preferably greater than 50% by weight based on the total weight of polymeric binders present is polyvinylpyrrolidone.

In one embodiment, the coating composition suitably comprises in the range from (i) 60 to 98%, preferably 70 to 95%, more preferably 80 to 92%, particularly 87 to 91%, and especially 88 to 90% by weight of polyvinylpyrrolidone, and (ii) 2 to 40%, preferably 5 to 30%, more preferably 8 to 20%, particularly 9 to 13%, and especially 10 to 12% by weight of polymeric binders other than polyvinylpyrrolidone; both based on the total weight of polymeric binders in the coating composition.

The polyvinylpyrrolidone used herein suitably has a molecular weight (weight average) in the range from 1,000 to 40,000, preferably 5,000 to 20,000, more preferably 9,000 to 11,000, particularly 9,500 to 10,500, and especially 9,800 to 10,200.

Any polymeric binders other than polyvinylpyrrolidone may be selected from the other polymeric binders described herein, and in particular from the group consisting of vinyl acetate copolymers, polyvinyl alcohols and mixtures thereof. Suitable vinyl acetate copolymers include vinyl acetate-Veova (or vinyl versatate) copolymers, ethylene-vinyl acetate copolymers, vinyl acetate-(meth)acrylic/(meth)acrylate copolymers, and particularly vinyl acetate-Veova copolymers. Veova™ is a vinyl ester (vinyl versatate) with various highly branched synthetic carboxylic acids, sold by Momentive Speciality Chemicals Inc.

In one embodiment, the polymeric binder in the coating composition comprises, consists essentially of, or consists of a mixture of polyvinylpyrrolidone, polyvinyl alcohol and vinyl acetate copolymer, preferably vinyl acetate-Veova copolymer.

The ratio of vinyl acetate copolymer, preferably vinyl acetate-Veova copolymer, to polyvinyl alcohol present in the coating composition is suitably in the range from 0.1 to 10.0:1, preferably 0.3 to 3.0:1, more preferably 0.6 to 2.0:1, particularly 1.0 to 1.2:1, and especially 1.05 to 1.15:1 by weight.

The polyvinyl alcohol suitably has a molecular weight (weight average) in the range from 2,000 to 100,000, preferably 25,000 to 60,000, more preferably 35,000 to 45,000, particularly 38,000 to 41,000, and especially 39,000 to 40,000.

The vinyl acetate copolymer, preferably vinyl acetate-Veova copolymer, suitably has a molecular weight (weight average) in the range from 2,000 to 100,000, preferably 20,000 to 70,000.

The molecular weight (weight average) of the polymeric binders described herein can be determined by techniques well known in the art such as light scattering, size exclusion HPLC or mass spectrometry, preferably by mass spectrometry.

The amount of polymeric binder in the seed coating composition is suitably in the range from 3 to 40%, preferably 6 to 25%, more preferably 8 to 12%, particularly 9.4 to 9.9%, and especially 9.6 to 9.7% by weight based on the total weight of the composition.

The seed coating composition comprises a filler selected from those with bulk density in the range 0.05 to 0.80 mg/L. It is envisaged that use of fillers of low bulk density will provide for the advantages described for the seed coating composition.

The bulk density of the filler may preferably be in the range 0.10 to 0.70 mg/L, more preferably in the range 0.15 to 0.60 mg/L, more preferably in the range 0.20 to 0.50 mg/L. Further preferably, the bulk density of the filler is in the range 0.25 to 0.45 mg/L.

It will be understood that, unless stated otherwise, bulk density values described herein refer to loose bulk density, and this is determined pursuant to International Standard ASTM D7481-18, (2018), “Standard Test Methods for Determining Loose and Tapped Bulk Densities of Powders using a Graduated Cylinder”.

The filler component of the seed coating composition may be any suitable organic or inorganic material. By definition as used herein, the filler component excludes any fibrous material. A suitable organic filler material is corn starch powder. Suitable inorganic filler materials include at least one selected from the group consisting of talc, mica, kaolin, diatomaceous earth, pumice, perlite, calcium carbonate, silica, silicates, barium sulphate, titanium dioxide, calcium silicates, and calcium sulphate, preferably talc and calcium silicate.

The filler component may comprise a mixture of two or more of the suitable fillers noted herein, preferably a combination of two.

The filler preferably comprises, consists essentially of, or consists of talc and calcium silicates.

In a particularly preferred embodiment the filler is selected from talc or calcium silicate, or a combination thereof, where the bulk density of the filler is in the range 0.25 to 0.45 mg/L.

The filler is preferably in particulate form and may, for example, be irregularly shaped, spherical, approximately spherical, disc, platelet, needle-like or rod shaped. The filler is preferably platy or need-like in particle shape. The filler component is non-fibrous.

In one embodiment, the filler, preferably talc, suitably has a median particle size as determined by x-ray sedimentation using a Sedigraph III Plus Particle Size Analyzer, in the range from 0.1 to 50 μm, preferably 1 to 25 μm, more preferably 1.5 to 10 μm, particularly 2 to 8 μm, and especially 3 to 5 μm.

In an alternative embodiment, the filler, preferably calcium silicate, suitably has a median particle size as determined by x-ray sedimentation using a Sedigraph III Plus Particle Size Analyzer, in the range from 2 to 30 μm, preferably 4 to 20 μm, more preferably 6 to 18 μm, particularly 10 to 16 μm, and especially 12 to 14 μm.

In a preferred embodiment, the filler may comprise two fillers of differing particle size. In particular, said combination may comprise fillers of particle sizes each of the embodiments as noted herein.

The filler particles preferably have a diameter in the range of 10-40 nanometers, preferably 12-35 nanometers, and more preferably 15-25 nanometers.

The individual particles suitably have a mean aspect ratio d1:d2 (where d1 and d2, respectively, are the length and width of the particle) in the range from 3 to 50:1, preferably 5 to 25:1, more preferably 7 to 15:1, particularly 8 to 12:1, and especially 9 to 11:1.

The mean length by number of the particles is suitably in the range from 20 to 1,000 μm, preferably 50 to 500 μm, more preferably 200 to 400 μm, particularly 260 to 340 μm, and especially 280 to 320 μm. The mean width by number of the particles is suitably in the range from 5 to 100 μm, preferably 10 to 50 μm, more preferably 20 to 40 μm, particularly 26 to 34 μm, and especially 28 to 32 μm.

The size of the particles can be determined by measuring the length and width of particles selected from a photographic image obtained by using a transmission electron microscope. At least 1,000 particles could be measured to ensure statistically accurate mean values.

The seed coating composition comprises fibrous material. The fibrous material may comprise any suitable organic or inorganic fibres or fibre particles. The fibres may be of a natural and/or synthetic material. Suitable fibres include vegetable fibres, wood fibres, and animal fibres.

Vegetable fibres are usually of cellulose, often in combination with lignin. Suitable examples include cotton, bamboo, hemp, jute, flax, ramie, sisal, bagasse, and banana.

Wood fibre is distinguished from vegetable fibre, as being from tree sources. Forms include groundwood, lacebark, thermomechanical pulp (TMP), and bleached or unbleached kraft or sulphite pulps. Lignin is removed in the Kraft and sulphite type of pulping process.

Animal fibres are largely protein based. Examples include silkworm silk, spider silk, sinew, catgut, wool, sea silk and hair such as cashmere wool, mohair and angora, fur such as sheepskin, rabbit, mink, fox, beaver, etc.

The individual fibre particles suitably have a mean aspect ratio d₁:d₂ (where d₁ and d₂, respectively, are the length and width of the fibre) in the range from 3 to 50:1, preferably 5 to 25:1, more preferably 7 to 15:1, particularly 8 to 12:1, and especially 9 to 11:1. The mean length by number of the fibres is suitably in the range from 20 to 1,000 μm, preferably 50 to 500 μm, more preferably 200 to 400 μm, particularly 260 to 340 μm, and especially 280 to 320 μm. The mean width by number of the fibres is suitably in the range from 5 to 100 μm, preferably 10 to 50 μm, more preferably 20 to 40 μm, particularly 26 to 34 μm, and especially 28 to 32 μm.

The size of the fibre particles can be determined by measuring the length and width of fibres selected from a photographic image obtained by using a transmission electron microscope. At least 1,000 fibre particles could be measured to ensure statistically accurate mean values.

The fibrous material used in the present invention preferably comprises, consists essentially of, or consists of cellulose fibres. The cellulose fibres may be natural fibres or manufactured fibres (i.e. formed into a pulp and then extruded), preferably are natural fibres. The cellulose fibres may be in their natural chemical form or chemically modified, preferably are non-chemically modified.

The cellulose fibres preferably comprise, consist essentially of, or consist of, substantially non-chemically modified and/or non-chemically derivatised cellulose. Preferably, at least 95%, more preferably at least 98%, and particularly at least 99% by weight of the cellulose fibres are of non-modified and/or non-derivatized cellulose.

By cellulose will be understood to mean material comprising organic polysaccharide compounds having the repeating monomer formula (C₆H₁₀O₅)ₙ, with each glucose monomer unit linked via a glycosidic β(1→4) bond to an adjacent monomer.

The cellulose fibres may be homogeneous in that they are comprised of only one specific type of cellulose, for example all having identical molecular weights. In an alternative embodiment, the cellulose fibres may be heterogeneous in that they comprise a mixture, such as a mixture having different molecular weights.

Cellulose is, of course, preferably derived from natural sources (for example, wood pulp cellulose, cotton derived cellulose, or bamboo derived cellulose), and as such the cellulose fibres so derived will comprise multiple similar constituents depending on the source. The cellulose fibres are preferably derived from wood pulp. Cellulose fibres derived from hard woods may be preferred.

The cellulose fibres used in the present invention may comprise cellulose comprising in the range from 500 to 20,000, preferably 1,000 to 15,000, more preferably 2,000 to 10,000 monomer units.

The cellulose fibres may comprise several known types of cellulose such as alpha-cellulose (α-cellulose), beta-cellulose (β-cellulose) and gamma-cellulose (γ-cellulose).

In one embodiment, the cellulose fibres suitably comprise a high α-cellulose content, preferably greater than 70%, more preferably greater than 80%, particularly greater than 90%, and especially greater than 98% by weight.

The carboxyl content of the cellulose fibres may be less than 5 mol. %, preferably less than 1 mol. %.

The cellulose fibres may have a low ash content, preferably lower than 1%, more preferably lower than 0.75%, and particularly lower than 0.5% by weight.

The cellulose fibres preferably have a bulk density in the range from 20 to 200 g/I, more preferably 40 to 100 g/I, and particularly 60 to 80 g/I.

Fibre particle sizes (or any other non-spherical forms) can be normalized or converted to spherical diameters of said fibres. In the form of a distribution of particle sizes, the fibre particles have a median volume particle diameter value. It will be understood that the median volume particle diameter refers to the equivalent spherical diameter corresponding to the point on the distribution which divides the population exactly into two equal halves. It is the point which corresponds to 50% of the volume of all the fibre particles, read on the cumulative distribution curve relating volume percentage to the diameter of the particles i.e. 50% of the distribution is above this value and 50% is below. This value is referred to as the “D(v,0.5)” value and is suitably determined as described herein.

Additionally, “D(v,0.9)” and “D(v,0.1)” values can also be referred to, and these values are the equivalent spherical diameter corresponding to 90% or 10% respectively of the volume of all the fibre particles, read on the cumulative distribution curve relating volume percentage to the diameter of the particles, i.e. they are the points where 10% or 90% of the distribution is above this value and 90% or 10% are below the value respectively.

The fibre particle size values, used to determine the D(v,0.5), D(v,0.1), and D(v,0.9) values, are suitably measured by techniques based on dynamic light scattering analysis, preferably using the specific method as herein described.

It has been found that the median size and/or size distributions of the fibres, preferably cellulose fibres, can be important parameters in obtaining a seed coating composition having the desired properties.

The fibre, preferably cellulose fibre, particles suitably have a D(v,0.5) value in the range from 10 to 120 μm, preferably 30 to 100 μm, more preferably 45 to 75 μm, particularly 55 to 65 μm, and especially 58 to 62 μm.

The fibre particles suitably have a D(v,0.9) value of less than 700 μm, preferably less than 500 μm, more preferably less than 400 μm, particularly less than 350 μm, and especially less than 300 μm.

Suitably, the fibre particles have a D(v,0.9) value of greater than 70 μm, more preferably greater than 150 μm, particularly greater than 230 μm, and especially in the range from 250 to 290 μm.

The fibre particles suitably have a D(v,0.1) value of less than 25 μm, more preferably, less than 20 μm, particularly less than 18 μm, and especially less than 17 μm.

Suitably the fibre particles have a D(v,0.1) value of greater than 5 μm, more preferably, greater than 8 μm, particularly greater than 12 μm, and especially in the range from 14 to 16 μm.

The ratio of the values of D(v,0.9) to D(v,0.1) represents the width of the particle size distribution, and therefore how defined the distribution is around the median particle size value. The ratio of D(v,0.9) to D(v,0.1) values for the fibre particles is preferably in the range from 5 to 40:1, more preferably 10 to 30:1, particularly 15 to 25:1, and especially 17 to 20:1.

The width of the distribution may also be represented by the difference between the D(v,0.9) and D(v,0.1) values. The difference in the D(v,0.9) and D(v,0.1) values for the fiber particles is suitably in the range from 50 to 600 μm, preferably 120 to 400 μm, more preferably 180 to 330 μm, particularly 220 to 290 μm, and especially 240 to 270 μm.

The weight average molecular weight of the fiber, preferably cellulose fiber, particles is preferably in the range from 1,000 to 10,000,000, more preferably 50,000 to 5,000,000, and especially 100,000 to 2,000,000.

Suitable cellulose fibers are commercially available, for example, from CreaFill Fibers Corp. of Chestertown, Maryland, USA under the CreaTech trade mark, or from J. Rettenmaier & Söhne Gmbh of Rosenberg, Germany under the Arbocel trade mark.

The seed coating composition may also include other components as desired. These other components may be selected from those including:
diluents, absorbents or carriers such as carbon black; talc; diatomaceous earth; kaolin; aluminium, calcium or magnesium stearate; sodium tripolyphosphate;
sodium tetraborate; sodium sulphate; sodium, aluminium and mixed sodium-aluminium silicates; and sodium benzoate,
wetting agents such as alcohol ethoxylate and alcohol ethoxylate/propoxylate wetting agents;
dispersants such as sulphonated naphthalene formaldehyde condensates and acrylic copolymers such as the comb copolymer having capped polyethylene glycol side chains on a polyacrylic backbone;
emulsifiers such as alcohol ethoxylates, ABA block co polymers, or castor oil ethoxylates;
antifoam agents, e.g. polysiloxane antifoam agents, typically in amounts of 0.005 wt. % to 10 wt. % of the formulation;
viscosity modifiers such as commercially available water soluble or miscible gums, e.g. xanthan gums, and/or cellulosics, e.g. carboxy-methyl, ethyl or propylcellulose; and/or
preservatives and/or anti-microbials such as organic acids, or their esters or salts such as ascorbic e.g. ascorbyl palmitate, sorbic e.g. potassium sorbate, benzoic e.g. benzoic acid and methyl and propyl 4-hydroxybenzoate, propionic e.g. sodium propionate, phenol e.g. sodium 2-phenylphenate; 1,2-benzisothiazolin-3-one; or formaldehyde as such or as paraformaldehyde; or inorganic materials such as sulphurous acid and its salts, typically in amounts of 0.01 wt. % to 1 wt. % of the formulation.

The seed coating composition of the invention may also comprise a surface active agent such as a wetting, dispersing and/or emulsifying agent. The surface active agent may aid in mixing/emulsifying/dispersing the pigment particles in the pre-blend and seed coating composition. Suitable surface active agents include ionic and non-ionic products and include solutions of organo-modified polyacrylates, polyacrylates, sodium polyacrylate, polyurethane, phosphoric acid ester, star polymers, and/or modified polyethers.

The seed coating composition of the invention may comprise further components such as one or more selected from a solvent, a thickener, an anti-foaming agent, a preservative, and a slip additive.

Suitable thickeners include agar, carboxy methylcellulose, carrageenan, chitin, fucoidan, ghatti, gum arabic, karaya, laminaran, locust bean gum, pectin, alginate, guar gum, xanthan gum, diutan gum, and tragacanth, bentonite clays, HEUR (hydrophobically modified, ethoxylated urethane) thickeners, HASE (hydrophobically modified, alkali-swellable emulsion) thickeners and polyacrylates. Gums are generally preferred because of their low cost, availability and superior ability to enhance the physical characteristics of the resultant coated film.

Examples of suitable antifoaming agents include polyethylene glycol, glycerine, mineral oil defoamers, silicone defoamers, and non-silicone defoamers (such as polyethers, polyacrylates), dimethylpolysiloxanes (silicone oils), arylalkyl modified polysiloxanes, polyether siloxane copolymer containing fumed silica. The antifoaming agent may be present in some embodiments of the seed coating composition in an amount of at least 1 ppm by weight, or 0.1 to 0.3% by weight based on the total weight of the seed coating composition.

The seed coating composition further may comprise one or more solvents other than water. Solvents may be selected from the group consisting of alcohols, and hydrocarbons. Also mixtures of solvents can be used. It is preferred that the solvent is liquid at 20° C. and 1 atm. Examples of suitable solvents include glycols and their esters and ethers, in particular ethylene and propylene glycols and their esters and ethers, for instance, esters and ethers with C₁-C₆ alkyl groups and/or aromatic groups, such as methyl, ethyl, propyl, butyl, benzyl and phenyl ethers, including mono ethers and dialkyl ethers, and esters of these ethers, such as acetates, and ethylene and propylene glycol esters, for instance of fatty acids; polyethylene glycol (PEG) and polypropylene glycol and esters thereof, especially with fatty acids; butyl cellosolve, butyl carbitol, polyethylene glycol; N methylpyrrolidone, glycerine, alkyl alcohols with up to 10 carbon atoms, such as ethanol, propanol and butanol. Other examples of solvents include dipropylene glycol methyl ether and propylene glycol methyl ether. An important solvent is ethylene glycol. Further examples include propylene tetramer and synthetic ester oils such as lactate esters, particularly ethyl lactate and benzoate esters e.g. iso-propyl or 2-ethylhexyl benzoates. Aromatic hydrocarbons such as xylene, aliphatic and paraffinic solvents and vegetable oils can also be used as solvent. Aromatic solvents are less preferred.

The seed coating composition may also comprise components with a plasticising effect, such as surfactants or antifreeze agents. Common surfactants include amphiphilic organic compounds, usually comprising a branched, linear or aromatic hydrocarbon, fluorocarbon or siloxane chain as tail and a hydrophilic group. Some types of surfactants include non-ionic, anionic, cationic and amphoteric surfactants, and organosilicone and organofluorine surfactants. Some examples of surfactants include polyoxyethylene glycol and polyoxypropylene ethers and esters, in particular alkyl, aryl and alkylaryl ethers thereof, and sulphates, phosphates and sulphonic acid compounds of such ethers, glucoside (alkyl) ethers, glycerol esters, such as alkyl and fatty acid esters, sorbitan (alkyl) esters, acetylene compounds, cocamide compounds, block copolymers of polyethylene glycol and propylene glycol. Further examples of surfactants include alkylamine salts and alkyl quaternary ammonium salts, for example betaine type surfactants, amino acid type surfactants; and polyhedric alcohols, fatty acid esters, in particular C₁₂-C₁₈ fatty acids, for instance of polyglycerin, pentaerythritol, sorbitol, sorbitan, and sucrose, polyhydric alcohol alkyl ethers, fatty acid alkanol amides, and propoxylated and ethoxylated compounds such as fatty alcohol ethoxylates, polyethyxlated tallow amine and alkylphenol ethoxylates. Some examples of anionic surfactants include carboxylic acids, copolymers of carboxylic acids, sulphates, sulphonic acid compounds and phosphates, for example lignin sulphonates and (linear) alkylaryl sulphonates.

Anti-freeze agents include for example: ethylene glycol, propylene glycol, 1,3 butylene glycol, hexylene glycol, diethylene glycol, and glycerin, with the preferred glycol being ethylene glycol and propylene glycol.

The seed coating composition of the present invention may also contain one or more optional pigments, which function to provide an aesthetic effect when coated on seed, or to identity which seeds have been treated. The pigment is preferably an inorganic material and may, for example, be an effect pigment and/or a coloured pigment as known in the art.

Examples of suitable effect pigments include pearlescent pigment in different particle sizes. Effect pigments having a particle size of 60 μm or less, or a particle size of 15 μm or less may be used. The particle size of the effect pigment is preferably not more than 200 μm, more preferably not more than 100 μm. Usually, the particle size of the effect pigment is 1 μm or more. Another effect pigment can be aluminium. Effect pigments can be used to create an attractive cosmetic look on the seeds.

Examples of coloured pigments include pigment red 112 (CAS No. 6535-46-2), pigment red 2 (CAS No. 6041-94-7), pigment red 48:2 (CAS No. 7023-61-2), pigment blue 15:3 (CAS No. 147-14-8), pigment green 36 (CAS No. 14302-13-7), pigment green 7 (CAS No. 1328-53-6), pigment yellow 74 (CAS No. 6358-31-2), pigment orange 5 (CAS No. 3468-63-1), pigment violet 23 (CAS No. 6358-30-1), pigment black 7 (CAS No. 97793 37 8), and pigment white 6 (CAS No. 98084-96-9). The particle size of the coloured pigment is preferably not more than 100 μm, more preferably not more than 50 μm. Usually, the particle size of the coloured pigment is 25 μm or more.

A dye such as anthraquinone, triphenylmethane, phthalocyanine, derivatives thereof, and diazonium salts, may be used in addition to or as an alternative to a coloured pigment.

The amount of pigment in the seed coating composition, if present, is suitably in the range from 0.1 to 15%, preferably 1.0 to 8.0%, more preferably 2.0 to 5.0%, particularly 2.5 to 3.5%, and especially 2.8 to 3.2% by weight based on the total weight of the composition.

The seed coating composition further comprises flakes of a translucent polymeric film on an inert carrier (a carrier which has no detectable, harmful consequences for the environment, in particular for the seed or the outgrowing plant in the quantities present) for providing the seeds with a light-reflecting appearance, such as described in WO 03/003812. Preferably, the translucent polymeric film comprises light reflecting particles.

A biocide can be included in some embodiments of the seed coating composition for instance as preservative, in order to prolong the shelf life of the seed coating composition before being applied to a seed, such as when being stored. Examples of suitable biocides include MIT (2 methyl 4-isothiazolin-3-one; CAS No. 2682 20-4), BIT (1,2 benzisothiazolin-3-one; CAS No. 2632-33-5)), CIT (5-Chloro-2-methyl-4-isothiazolin-3-one), Bronopol (2-Bromo-2-nitro-propane-1,3-diol) and/or a combination of these.

The seed coating composition may comprise one or more biologically active ingredients (including plant enhancing agents, in particular plant protective products (also referred to as PPPs)). Suitable examples of active ingredients, in particular plant enhancing agents, are fungicidal agents, bactericidal agents, insecticidal agents, nematicidal agents, molluscicidal agents, biologicals, acaricides or miticides, pesticides, and biocides. Further possible active ingredients include disinfectants, micro organisms, rodent killers, weed killers (herbicides), attracting agents, (bird) repellent agents, plant growth regulators (such as gibberellic acid, auxin or cytokinin), nutrients (such a potassium nitrate, magnesium sulphate, iron chelate), plant hormones, minerals, plant extracts, germination stimulants, pheromones, biological preparations, etc.

The amount of active ingredient applied, of course, strongly depends on the type of active ingredient and the type of seed used. Usually, however, the amount of one or more active ingredients is in the range of 0.001 to 200 g per kg of the seed. The skilled person is able to determine suitable amounts of active ingredient depending on the active ingredient and the type of seed used. It is common practice for the skilled person to use and follow the advice of the active ingredient suppliers (e.g., BASF, Bayer, Syngenta, DuPont, etc.), such as by using technical data sheets and/or following recommendations.

Typical fungicidal agents include Captan (N trichloromethyl)thio 4 cyclohexane 1,2-dicarboximide), Thiram tetramethylthioperoxydicarbonic diamide (commercially available as Proseed™), Metalaxyl (methyl N (2,6 dimethylphenyl)-N(methoxyacetyl) d,l-alaninate), Fludioxonil (4 (2,2 difluoro-1,3 benzodioxol-4-yl)-1H pyrrol-3-carbonitril; commercially available in a blend with mefonoxam as Maxim™ XL), difenoconazole (commercially available as Dividend™ 3FS), carbendazim iprodione (commercially available as Rovral™), ipconazole (commercially available as Rancona from Arista, formerly Agriphar or Chemtura), mefonoxam (commercially available as Apron™ XL), tebuconazole, carboxin, thiabendazole, azoxystrobin, prochloraz, prothioconazole (commercially available as Redigo from Bayer), sedaxane (commercially available as Vibrance from Syngenta), cymoxanil (1 (2 cyano-2-methoxyiminoacetyl) 3 ethylurea), fludioxonil, a mixture of metalaxyl, cymoxanil and fludioxonil commercially available as Wakil from Syngenta, and oxadixyl (N (2,6 dimethylphenyl)-2-methoxy-N (2 oxo 3 oxazolidinyl) acetamide). A fungicide can be included in the seed coating composition in an amount of 0.0001 to 10% by total weight of the coated seeds.

Typical bactericidal agents include streptomycin, penicillins, tetracyclines, ampicillin, and oxolinic acid.

Typical insecticidal agents include pyrethroids, organophosphates, caramoyloximes, pyrazoles, amidines, halogenated hydrocarbons, neonicotinoids, and carbamates and derivatives thereof. Particularly suitable classes of insecticides include organophosphates, phenylpyrazoles and pyrethoids. Preferred insecticides are those known as terbufos, chlorpyrifos, fipronil, chlorethoxyfos, tefluthrin, carbofuran, imidacloprid, and tebupirimfos. Commercially available insecticides include imidacloprid (commercially available as Gaucho™), and clothianidin (commercially available from Bayer as Poncho™), thiametoxam (commercially available from Syngenta as Cruiser™), thiacloprid (commercially available as Sonido from Bayer), Cypermetrin (commercially available from Chemtura as Langis™, methiocarb (commercially available as Mesurol from Bayer), fipronil (commercially available from BASF as Regent™), chlorantraniliprole (also known as rynaxypyr, 5-bromo-N-[4-chloro-2-methyl-6 (methylcarbamoyl)phenyl]-2-(3-chloropyridin-2-yl)pyrazole-3-carboxamide, commercially available as Coragen™ from DuPont) and cyantraniliprole (also known as cyazypyr,3-bromo-1-(3-chloro-2-pyridyl)-4′cyano-2′-methyl-6′-(methylcarbamoyl)-pyrazole-5-carboxanilide).

Commercially available nematicidal agents include abamectin (commercially available from Syngenta as Avicta™) thiodicarb (commercially available from Bayer as Aeris™).

Typical molluscicidal agents include metaldehyde (commercially available from Lonza as Meta™) or niclosamid (commercially available from Bayer as Bayluscide™), Cyazypir and Rynaxypir (available from DuPont).

Examples of suitable biologicals include bacilli, Trichoderma, rhizobia (for nitrogen fixation) and the like, which have been identified as seed treatment materials to protect plants and/or enhance their health and/or productive capacity.

These lists are not exhaustive, new active ingredients are continuously developed and can be incorporated in the seed coating composition.

Nutrients may be present in addition to, or as an alternative to, agrochemical actives. In such formulations the nutrient is typically in a dry form.

The nutrients may preferably be a solid phase nutrients. Solid nutrients are to be understood in the present invention as meaning substances whose melting point is above 20° C. (at standard pressure). Solid nutrients will also include insoluble nutrient ingredients, i.e. nutrient ingredients whose solubility in water is such that a significant solid content exists in the concentrate after addition.

Nutrients refer to chemical elements and compounds which are desired or necessary to promote or improve plant growth. Suitable nutrients generally are described as macronutrients or micronutrients. Suitable nutrients for use in the concentrates according to the invention are all nutrient compounds.

Micronutrients typically refer to trace metals or trace elements, and are often applied in lower doses. Suitable micronutrients include trace elements selected from zinc, boron, chlorine, copper, iron, molybdenum, and manganese. The micronutrients may be in a soluble form or included as insoluble solids, and may be salts or chelated.

Macronutrients typically refer to those comprising nitrogen, phosphorus, and potassium, and include fertilisers such as ammonium sulphate, and water conditioning agents. Suitable macro nutrients include fertilisers and other nitrogen, phosphorus, potassium, calcium, magnesium, sulphur containing compounds, and water conditioning agents.

Suitable fertilisers include inorganic fertilisers that provide nutrients such as nitrogen, phosphorus, potassium or sulphur. Fertilisers may be included in diluted formulations at relatively low concentrations or as more concentrated solutions, which at very high levels may include solid fertiliser as well as solution.

It is envisaged that inclusion of the nutrient would be dependent upon the specific nutrient, and that micronutrients would typically be included at lower concentrations whilst macronutrients would typically be included at higher concentrations.

Biostimulants may enhance metabolic or physiological processes such as respiration, photosynthesis, nucleic acid uptake, ion uptake, nutrient delivery, or a combination thereof. Non-limiting examples of biostimulants include seaweed extracts (e.g., ascophyllum nodosum), humic acids (e.g., potassium humate), fulvic acids, myoinositol, glycine, and combinations thereof.

The wax emulsion is suitably present in the seed coating composition at a concentration in the range from 0.5 to 25 wt. %, preferably 2 to 18 wt. %, more preferably 5 to 15 wt. %, in particular 8 to 12 wt. %.

A particular advantage of the present invention may be that the resulting seed coating composition may have lower levels of polymeric binder than may be seen in existing seed coating compositions. Typically, prior seed coatings comprise polymeric binders based in particular on poly vinyl or poly acrylate type chemistry.

The seed coating composition may comprise an amount of polymeric binder in the range from 0.5 to 20 wt. %, by total weight of the composition. Preferably, in the range from 1 to 10 wt. %. More preferably, in the range from 2 to 8 wt. %.

The amount of filler, in the seed coating composition is suitably in the range from 20 to 90%, preferably 35 to 80%, more preferably 45 to 70%, particularly 51 to 63%, and especially 55 to 59% by weight based on the total weight of the composition.

The amount of fibrous material, if present, in the seed coating composition is suitably in the range from 4 to 40%, preferably 8 to 25%, more preferably 11.0 to 18.0%, particularly 13.0 to 15.5%, and especially 14.0 to 14.5% by weight based on the total weight of the composition.

The ratio of filler particles, preferably talc, to fibrous material (if present), present in the seed coating composition is suitably in the range from 0.2 to 30.0:1, preferably 0.5 to 15.0:1, more preferably 2.0 to 8.0:1, particularly 3.0 to 5.0:1, and especially 3.5 to 4.5:1 by weight.

In one embodiment, the composition may be made in a ‘one-pot’ method where all components are added in.

In an alternative method or embodiment, a powder formulation or dry pre-blend, and an aqueous or liquid pre-blend are formed separately and then mixed together to form the seed coating composition of the invention.

The dry pre-blend and aqueous pre-blend may be formed in a different location to where the seed coating composition is formed, and preferably kept separate until the time of application of the seed coating composition to the seed, to form the coated seed.

The seed coating composition is suitably formed by combining the dry pre-blend and aqueous pre-blend, and any other optional components, e.g. biologically active ingredients; and simultaneously or shortly thereafter, e.g. within 5 hours, preferably within 30 minutes, applying to the seed. The seed coating process can range from a few seconds, e.g. from 15 seconds, to a few hours, e.g. up to 8 hours, depending on the type of seed, seed coating composition, build up level required and other variables. The dry pre-blend, aqueous pre-blend and other components are preferably added simultaneously to the seed, for at least part of the time, during the seed coating process.

The dry pre-blend is suitably a substantially anhydrous free flowing solid material which comprises, consists essentially of, or consists of, the filler and fibrous material, defined herein.

The aqueous pre-blend preferably comprises the wax emulsion and polymeric binder defined herein. The aqueous pre-blend may also comprise pigment, as defined herein, and any of the other optional seed coating composition components defined herein. The aqueous pre-blend may also contain one or more of the biologically active materials described herein. In addition, or alternatively, one or more biologically active materials may be added separately when the dry pre-blend and aqueous pre-blend are mixed together to form the seed coating composition of the present invention.

The aqueous composition pre-blend suitably comprises in the range from (i) 10 to 70%, preferably 20 to 60%, more preferably 25 to 55%, and especially 35 to 45% by weight of wax emulsion based, on the total weight of the composition; (ii) 1 to 20%, preferably 4 to 16%, more preferably 6 to 14%, and especially 8 to 12% by weight of wax emulsion based, on the total weight of the composition; (iii) 0 to 40%, preferably 2 to 25%, more preferably 5 to 15%, particularly 9 to 12%, and especially 10 to 11% by weight of pigment, based on the total weight of the composition; and/or (iv) 20 to 75%, preferably 35 to 70%, more preferably 45 to 65%, particularly 50 to 60%, and especially 54 to 57% by weight of water, based on the total weight of the composition.

The dry pre-blend comprises, consists essentially of, or consists of, in the range from (i) 30 to 99%, preferably 50 to 95%, more preferably 70 to 90%, particularly 75 to 85%, and especially 72 to 82% by weight of filler, based on the total weight of the composition; and/or (ii) 1 to 50%, preferably 5 to 35%, more preferably 10 to 30%, particularly 15 to 25%, and especially 16 to 20% by weight of fibre particles, based on the total weight of the composition.

In one embodiment, the seed coating composition according to the invention is formed by combining or mixing together components comprising, consisting essentially of, or consisting of, (i) the aqueous pre-blend defined herein, and (ii) the dry pre-blend defined herein, suitably at a ratio in the range from 0.05 to 3.0:1, preferably 0.10 to 1.0:1, more preferably 0.25 to 0.60:1, particularly 0.35 to 0.45:1, and especially 0.40:1 by weight, and optionally (iii) one or more biologically active ingredients defined herein.

The term “seed” as used in this application is meant to refer in particular to the ripened ovule of gymnosperms and angiosperms, which contain an embryo surrounded by a protective cover. In particular, the term covers field crop seeds, vegetable seeds, and cereal kernels. The protective cover can comprise the seed coat (testa). Some seeds comprise a pericarp or fruit coat around the seed coat. As used in this application, the term “seed coat” is meant to include a caryopsis or an achene. The term “seed” includes anything that can be planted in agriculture to produce plants, including pelleted seeds, true seeds, plant seedlings, rootstock, regenerable and plant forming tissue, and tubers or bulbs.

The seed is a plant seed, for example a seed of an agricultural or field crop, a vegetable seed, a herb seed, a wildflower seed, an ornamental seed, a grass seed, a tree seed, or a bush seed.

Preferably, the plant seed is of an agricultural crop or field crop. The seed may be of the order of Monocotyledoneae or of the order of Dicotyledoneae. Suitable seeds include seed of soybean, cotton, corn, peanut, maize, wheat, barley, oat, rye triticale, mustard, oil seed rape (or canola) sunflower, sugar beet, safflower, millet, chicory, flax, rapeseed, buckwheat, tobacco, hemp seed, alfalfa, signal grass, clover, sorghum, chick pea, beans, peas, vetch, rice, sugar cane, guayule, and linseed. Examples of suitable vegetable seeds include asparagus, chives, celery, leek, garlic, beetroot, spinach, beet, curly kale, cauliflower, sprouting broccoli, savoy cabbage, white cabbage, red cabbage, kohlrabi, Chinese cabbage, turnip, endive, chicory, water melon, melon, cucumber, gherkin, marrow, parsley, fennel, pea, beans, radish, black salsify, eggplant, sweet corn, pop-corn, carrot, onion, tomato, pepper, lettuce, snap bean, cucurbit, shallot, broccoli, Brassica, and Brussels sprout.

Preferably, the plant seed is selected from the group consisting of corn, soybean and rice, and particularly is corn.

Preferably, the plant seed is capable of germinating. Optionally, the seed may be deprived of husk (so called husked seed or de hulled seed).

Coating includes film coating, pelleting, and encrusting or a combination of these techniques as known in the art. It is envisaged that the present invention applies to all said coatings types, preferably to encrustment.

The seed coating composition of the invention may be applied to the seed in conventional manners.

The seed may be primed or not primed (having been subjected to a treatment to improve the germination rate, e.g. osmopriming, hydropriming, matrix priming).

In one embodiment, the seed is not provided with artificial layers prior to applying the seed coating composition of the invention, for example primer layers comprising a binder, such as a polymer. Accordingly, the seed coating composition is preferably applied directly on the natural outer surface of the seed. Nonetheless, it is possible that the seed surface has undergone a surface treatment prior to applying the seed coating composition.

Preferably, the seed coating composition is applied as a liquid composition and/or emulsion and/or dispersion and/or latex composition and thereafter solidified (including cured and/or dried) to form a seed coating. The term “liquid coating composition” as used in this application is meant to include coating compositions in the form of a suspension, emulsion, and/or dispersion, preferably a dispersion.

Conventional means of coating may be employed for coating the seeds. Various coating machines are available to the person skilled in the art. Some well-known techniques include the use of drum coaters, fluidised bed techniques, rotary coaters (with and without integrated drying), and spouted beds. Suitably, the seed coating composition is applied to the seed by a rotary coater, a rotary dry coater, a pan coater or a continuous treater.

Where the seed is encrusted, the amount of water in the seed coating composition is suitably less than 30%, preferably less than 25%, more preferably less than 20%, particularly in the range from 14.0 to 17.0%, and especially 15.0 to 16.0% by weight based on the total weight of the composition.

In an alternative embodiment where the seed is film coated, the amount of water in the seed coating composition is suitably in the range from 20% to 80%, preferably in the range from 30% to 70%, more preferably in the range from 40% to 60% by weight based on the total weight of the composition.

Typically, the amount of seed coating composition applied to the seed can be in the range of 10 to 1,000 g dry wt. per kg seed, such as 30 to 650 g dry wt. per kg seed, 100 to 400 g dry wt. per kg seed, or 150 to 250 g dry wt. per kg seed.

The seed coating composition can, for instance, be applied by encrusting, film coating, spraying, dipping, or brushing of the seed coating composition. Optionally, it is applied at a temperature of 2 to 50° C., for instance 5 to 35° C., more often 15 to 30° C., for instance at room temperature, such as 18 to 25° C. Preferably, the seed coating composition is applied to the seed by encrusting. The seed coating may suitably be applied by spraying the liquid aqueous composition pre-blend onto the seed, while also applying the powder pre-blend, typically while the seeds move within a coating apparatus. Preferably, the method comprises applying the seed coating composition to form an encrustment layer.

The seed coating composition is suitably applied to the seed such that the ratio of the dried coating layer to seed is suitably in the range from 0.001 to 20:1, preferably 0.05 to 10:1, more preferably 0.01 to 1.0:1, particularly 0.05 to 0.5:1, and especially 0.1 to 0.2:1 by weight.

Seed coating typically involves forming on the surface of the seeds a firmly adhering, moisture permeable coating. The process typically comprises applying a liquid seed coating composition to the seeds before planting.

An additional film coat layer may optionally be applied over the top of the coating, preferably encrustment, layer of the invention to provide additional benefits, including but not limited to cosmetics, coverage, actives, nutrients, and processing improvements such as faster drying, seed flow, durability and the like.

A particular advantage of the present invention may be that the film and resulting seed coating composition may be free or substantially free of microplastic and/or microplastic particles.

The term “microplastic” and “microplastic particles” as used in this application is meant to refer in particular to material consisting of solid polymer-containing particles, to which additives or other substances may have been added, and where more than 1% w/w of particles have dimensions between 1 nm and 5 mm, or for fibres a length of 3 nm to 15 mm and length to diameter ratio of greater than 3. Said polymers would not include those which are naturally occurring and not chemically.

The seed coating composition as defined herein may exhibit desired properties, including good abrasion resistance, freeze thaw resistance, good cosmetic appearance, good coating durability, and quicker coating cure times.

In particular, the seed coating composition may provide for an ability to encrust or coat seeds at lower size build up, thereby providing greater thickness with less coating composition. This may allow for use of lower levels of polymeric binder for said seed coating.

All of the features described herein may be combined with any of the above aspects, in any combination.

### EXAMPLES

In order that the present invention may be more readily understood, reference will now be made, by way of example, to the following description. It will be understood that all tests and physical properties listed have been determined at atmospheric pressure and room temperature (i.e. 25° C.), unless otherwise stated herein, or unless otherwise stated in the referenced test methods and procedures.

Several liquid binder formulations were formulated according to Table 1. All formulations were prepared on a high-speed disperser equipped with a Cowles Blade.

TABLE 1
Composition of Liquid Blends

| | Bin- | Bin- | Bin- | Bin- |
|---|---|---|---|---|
| Description | der 1 | der 2 | der 3 | der 4 |
| Water | 27.80 | 26.29 | 19.90 | 2.51 |
| Red Pigment Dispersion | 7.00 | 7.00 | 7.00 | 7.00 |
| Biocide | 0.19 | 0.19 | 0.19 | 0.19 |
| Xanthan Gum | 0.20 | | | |
| Vinyl Acetate-VEOVA Copolymer | 10.00 | 7.00 | | |
| Poly(vinyl pyrrolidone)/poly(vinyl | | | 20.00 | 28.00 |
| acetate) copolymer | | | | |
| Polyethylene Wax Emulsion | 40.00 | | | |
| Fischer Tropp Wax Emulsion | | | 40.00 | |
| Fischer Tropp/Polyethylene Wax | | 40.00 | | |
| Emulsion | | | | |
| Rice Bran Wax Emulsion | | | | 30.00 |
| Anionic Polymeric Surfactant Dispersant | 1.00 | 0.80 | 0.20 | |
| Star-Structure Polymeric Dispersant | | | | 1.00 |
| High HLB Polymeric Emulsifier Wetting | | | | 2.00 |
| Agent | | | | |
| Poly(siloxane) Defoamer | 0.01 | 0.02 | 0.01 | 0.30 |
| High-Shear HEUR Rheology Modifier | 3.90 | 4.00 | | |
| Low-shear HEUR Rheology Modifier | | | 3.95 | |
| Propylene Glycol | | 1.70 | 1.75 | 3.00 |
| 3.5 μm Huntite | 7.50 | 10.00 | | |
| 10.5 μm Talc | 2.40 | | | |
| 7.5 μm Talc | | | | 26.00 |
| Effect Pigment | | 3.00 | 7.00 | |

All values are expressed as wt. %.

Powder formulations were blended according to Table 2. All powder formulations were mixed in a ribbon blender until homogeneously blended.

TABLE 2
Composition of Powder Blends

| | Bulk | Powder | Powder | Powder |
|---|---|---|---|---|
| | Density | A | B | C |
| Description | (g/mL) | (wt. %) | (wt. %) | (wt. %) |
| Sodium starch glycolate | n/a | 3.90 | 3.00 | |
| 13 μm Wollastonite | 0.38 | 30.10 | | |
| 5 μm Microcrystalline talc | 0.32 | 48.00 | 67.00 | |
| 13 μm Platy talc | 0.4 | | | 80.00 |
| 200 μm cellulose fibers | 0.085 | 18.00 | 20.00 | 20.00 |
| 28 μm Perlite | 0.08 | | 10.00 | |

### Test Methods

The following test methods were used to determine performance of the encrusted seed objects.

### Wet Abrasion

Wet abrasion for encrustment occurs during the application of the seed encrustment due to the large volume of binder and powder applied to the seed. If the coating does not have adequate strength and durability while still wet, the coating will become uneven or be deposited in the walls of the seed treater due to the force of the seed dislodging the coating. This results in encrusted seed which has unacceptable on seed performance and appearance.

Wet abrasion score is evaluated after seed coating and drying to visually quantify the abrasion of the coating during application of the encrustment. Wet abrasion of the seed was allocated from 0 (high abrasion resistance/good quality seeds) to 5 (low abrasion resistance/poor quality seed).

### Dry Flowability

The low of treated/coated seeds is important at the seed treating facility as well as during seed sowing by the farmer. The lower the friction between the seeds, the better is the efficiency at various stages. Typically, the addition of PPPs and traditional film-coats to seeds slows down the flow of seeds considerably, which is not a desired characteristic. It can be improved by incorporating a flow agent or a slip agent into the film coat formulation. A flow agent is typically a wax-based additive that lowers friction and improves the appearance of the seed.

For testing the dry flow of treated seeds, 1 kg of seeds are placed in a funnel fitted with a stopper of 35 mm diameter. The stopper is opened and a timer started simultaneously. Dry flow of seeds were measured based on the time it took for the totality of the seeds to flow through the funnel. The measurement is run in triplicate 24 hours after treatment. The results are normalized versus the untreated seeds (untreated control or UTC) and reported % UTC.

### Seed Coating Weight

Seed coating weight for the treated seeds was obtained by comparing thousand seed weights (TSW) of the different samples. 1000 seeds are counted and the seeds weighed to obtain a TSW in g/1000 seeds.

Sample coating weight is calculated by (TSW sample/TSW raw seeds)*1000 to obtain a coating weight in g coating/1 kg seeds.

### Dust-Off and Dry Abrasion

Dust data for corn seeds treated with film-coats or encrustment were obtained by following industry standards. 100 grams of seeds were submitted to a 2-minute Heubach test in duplicate, averaging the results to a total amount of dust-off per 100 kg seeds.

Abrasion of corn seeds was visually observed after a 10 minute abrasion test run in a PharmaTest PTF20E friability drum rotating at a speed of 25 rpm.

The abrasion score is a visual quantification of the quality of seeds after subjecting them to this abrasion test closely simulating handling conditions in the industry.

The abrasion score was allocated from 0 (high abrasion resistance/good quality seeds) to 5 (low abrasion resistance/poor quality seeds). The test is performed after 3 days of drying to determine the dry abrasion score.

The results show the dust (in g/100,000 seeds) for the different film-coat formulations tested on corn, as well as abrasion scores determined after 10 min abrasion test (0: high abrasion resistance; 5: poor abrasion resistance).

These results show that the new compositions enable a good reduction of both dust and abrasion values on corn.

### Particle Size

The following test method was used; —particle size values, used to determine the D(v,0.5), D(v,0.1), and D(v,0.9) values of the fibrous material herein, were determined by dynamic light scattering analysis by using a Malvern Mastersizer 2000 with a Hydro 2000SM attachment running on water set at 2,100 rpm.

The refractive index of the material was set as 1.53 with an absorbance of 0.1. 12,000 snaps were taken over 12 seconds to obtain the data. An average of three runs was used to determine the final particle size. From the particle size values obtained, D(v,0.5), D(v,0.1), and D(v,0.9) values were readily determined.

### Formation

Seed coatings were prepared in batch-style rotary seed coater. First a plant protection product (PPP) cocktail of 8% Syngenta Vibrance Cinco, 39% Syngenta Cruiser 5FS, 3% red colorant, 34% Binder (from Table 1), and 16% water such that 14 g PPP cocktail/kg seeds and 4.22 g of binder/kg seed was applied.

After a combination of binder and powder were applied to the seed resulting in a total coating (g coating/kg of seed) as outlined in Table 3.

A filmcoat only reference was prepared by using only the PPP cocktail and using DISCO AG Clear L-650 as the binder such that 4.22 g L-650/kg seed was applied. After application of PPPs, binder, and powder, the seed is dried over warm air for 5 minutes to remove excessive moisture.

TABLE 3
Composition of seed coatings.

Seed Coat

| | A1 | A2 | A3 | A4 | A5 | A6 | A7 |
|---|---|---|---|---|---|---|---|
| Binder 1 | 53 | 42 | 63 | | | | |
| Binder 2 | | | | 50 | | | |
| Binder 3 | | | | | 49 | | |
| Binder 4 | | | | | | 67 | |
| Binder 5 | | | | | | | 47 |
| Powder A | 47 | 58 | 37 | 50 | 51 | 33 | |
| Powder B | | | | | | | |
| Powder C | | | | | | | 53 |

All values are expressed as wt. %.

### Results

The prepared seeds after curing for 24 hours were evaluated for total coating weight increase with the results in Table 4.

Theoretical coating weight is calculated by Coating weight (g/kg seed)=(% solids in binder)*(g binder applied)+(g powder applied).

Nearly all seed samples achieve similar coating weights to the theoretical value. This indicates a majority of the binder and powder are being applied to the seed.

TABLE 4
Coating weight analysis of treated seeds.

| | Theoretical | Actual |
|---|---|---|
| | Coating Weight | Coating Weight |
| Description | (g/kg seed) | (g/kg seed) |
| Untreated seeds | n/a | n/a |
| Filmcoat Control | 0 | 1 |
| Seed Coat A1 | 18 | 19 |
| Seed Coat A2 | 97 | 100 |
| Seed Coat A3 | 53 | 46 |
| Seed Coat A4 | 88 | 82 |
| Seed Coat A5 | 93 | 98 |
| Seed Coat A6 | 57 | 55 |
| Seed Coat A7 | 47 | 48 |

The coated seeds were tested for dust-off (g/100 kg seed), abrasion resistance, and dry flowability with the results shown in Table 5.

Many of the coatings have better abrasion resistance than the filmcoat control and raw seeds. The coatings of this invention show good abrasion resistance across a broad range of coating weights from 50-200 g/kg seed.

Dust-off for most seed coatings are similar or slightly higher than L-650. As the coating weight increases, the dust-off also increases, more water is introduced into the binder, the dust-off of the coating increases due to lower amounts of binder in the formula.

All coatings had similar flowability as the filmcoat reference indicating the coatings maintain good flowability across a variety of formulations and coating weights.

TABLE 5
Dust-off, abrasion resistance, and flowability of seed coatings.

| | Dust-off | | | |
|---|---|---|---|---|
| | (g/100 kg | Wet | Dry | Flowability |
| Description | seed) | Abrasion | Abrasion | (% UTC) |
| Untreated seeds | 0.535 | n/a | n/a | 100 |
| Filmcoat Control | 0.33 | 1.51 | 2.2 | 79 |
| Seed Coat A1 | 0.465 | 0.83 | 0.89 | 83 |
| Seed Coat A2 | 0.375 | 0.91 | 0.82 | 81 |
| Seed Coat A3 | 0.185 | 0.94 | 0.86 | 80 |
| Seed Coat A4 | 1.02 | 0.8 | 0.92 | 78 |
| Seed Coat A5 | 0.325 | 0.78 | 0.8 | 81 |
| Seed Coat A6 | 0.89 | 0.85 | 0.95 | 82 |
| Seed Coat A7 | 0.72 | 1.07 | 1.14 | 80 |

It is to be understood that the invention is not to be limited to the details of the above embodiments, which are described by way of example only. Many variations are possible.

1. A seed coating composition comprising:
wax emulsion;
polymeric binder;
filler selected from those with bulk density in the range 0.05 to 0.80 g/mL; and
fibrous material.

2. The seed coating composition according to claim 1, wherein the wax emulsion is selected from the group consisting of polyethylene wax, carnauba wax, paraffin wax, polypropylene wax, oxidised polyethylene wax, montan wax, ceresin wax, ozocerite, peat wax, Fischer Tropsch wax, amide wax, ethylene acrylic acid wax, polyolefin wax, ethylene bis stearamide wax, bees wax, lanolin wax, sugar cane wax, palm wax, and vegetable wax.

3. The seed coating composition according to claim 1, wherein wax emulsion has a molecular weight (weight average) in the range from 1,000 to 40,000.

4. The seed coating composition according to claim 1, wherein the polymeric binder is selected from the group consisting of polyvinyl acetates, polyvinyl acetate copolymers, polyvinyl alcohols, polyvinylpyrrolidones, and polyacrylates.

5. The seed coating composition according to claim 4, wherein polymeric binder in the coating composition comprises polyvinylpyrrolidone, and greater than 30% by weight based on the total weight of polymeric binders present is polyvinylpyrrolidone.

6. The seed coating composition according to claim 1, wherein the amount of polymeric binder in the seed coating composition is in the range from 3 to 40% by weight based on the total weight of the composition.

7. The seed coating composition according to claim 1, wherein the filler is an inorganic filler material selected from the group consisting of talc, mica, kaolin, diatomaceous earth, pumice, perlite, calcium carbonate, silica, silicates, barium sulphate, titanium dioxide, calcium silicates, and calcium sulphate.

8. The seed coating composition according to claim 1, wherein the filler is selected from talc or calcium silicate.

9. The seed coating composition according to claim 1, wherein the filler is in particulate form, the particles have a diameter in the range of 10-40 nanometers.

10. The seed coating composition according to claim 1, wherein the fibrous material comprises cellulose fibres.

11. The seed coating composition according to claim 10, wherein the cellulose fibres comprise cellulose in the range from 500 to 20,000 monomer units.

12. The seed coating composition according to claim 10, wherein the cellulose fibres comprise a high α-cellulose content greater than 70% by weight.

13. The seed coating composition according to claim 10, wherein the cellulose fibres have a D(v,0.5) value in the range from 10 to 120 μm.

14. A method of forming a seed coating composition according to claim 1, which comprises combining
a dry or substantially dry composition pre-blend comprising a filler selected from those with bulk density in the range 0.05 to 0.80 g/mL, and a fibrous material; and
a liquid pre-blend comprising wax emulsion and polymeric binder.

15. A method of coating seed which comprises applying to a seed the seed coating composition according to claim 1.

16. Seed with a coating comprising wax emulsion, polymeric binder, filler selected from those with bulk density in the range 0.05 to 0.80 g/mL, and a fibrous material.

17. Use of a seed coating composition comprising wax emulsion, polymeric binder, filler selected from those with bulk density in the range 0.05 to 0.80 g/mL, and a fibrous material, to reduce drying time when the composition is coated onto seed.
